(19) United States
(12) Patent Application Publication
(10) Pub. No.: US 2003/0086143 A1
(43) Pub. Date: May 8, 2003

(54) Scanner photoelectric module with adjustable lens and charge-coupling device

(75) Inventor: Jenn-Tsair Tsai, Taipei Hsien (TW)

Correspondence Address: LOWE HAUPTMAN GILMAN & BERNER, LLP, Suite 300, 1700 Diagonal Road, Alexandria, VA, 22314, US

(73) Assignee: Mustek Systems Inc.

(21) Appl. No.: 10/316,886

(22) Filed: Dec. 12, 2002

Related U.S. Application Data
(63) Continuation of application No. 09/427,979, filed on Oct. 26, 1999, now abandoned.

(30) Foreign Application Priority Data
Nov. 7, 1998 (TW) 87118572

(51) Int. Cl. G02B 26/08

(52) U.S. Cl. 359/210; 358/483

(57) ABSTRACT

A scanner photoelectric module with adjustable lens and charge-coupled device (CCD) module includes a supporting device, a lens module and a charge-coupled device module. The supporting device is arranged on an optical axle and has two planes vertical to the optical axle. The lens module and the charge-coupled device module are arranged on the two planes of the supporting device, respectively. The lens module can be arranged at one side of the supporting device for rotating around the optical axle. The charge-coupled device module can be arranged at the other side of the supporting device for moving horizontally (or rotating around the optical axle).

### BACKGROUND OF THE INVENTION

1. Field of the Invention

This invention relates to a photoelectric scanner module, particularly to a scanner photoelectric module with adjustable lens and charge-coupled device (CCD) module, wherein the lens module is arranged at one side of a supporting device for moving back and forth along an optical axle, and the charge-coupled device module is provided with horizontally (or vertically) extended screw holes to fasten the charge-coupled device module at the other side of the supporting device, for moving horizontally along the optical axle or rotating around the optical axle.

2. Description of the Prior Art

FIGS. 1-4 (Prior Art) are diagrams illustrating a method and system of adjusting the charge-coupling device and lens of the scanner module as specified in the Patent Publication No. 316969 of the Republic of China.

In FIG. 1, a scanner module 22 is first arranged on an adjusting assembly platform 24 when adjusting a lens 30 and a charge-coupled device 20. The charge-coupled device 20 is placed in front of the scanner module 22 through a holder 28, as shown in FIG. 2A. The holder 28 can move at X and Y directions and rotate at θ direction. The scanner module 22 further includes a light source 39, reflective mirrors 31, 33, 35 and a lens 30, as shown in FIG. 2B.

FIG. 3 illustrates a reference pattern for position adjusting of the lens 30 and the charge-coupled device 20. The triangles 42 and 45 determine whether the charge-coupled device 20 is horizontal. The straight lines 40 at two sides determine whether the scan area is located at the center of the charge-coupled device 20. The parallel lines 44 determine the MTF value of the scanner photoelectric module 22. FIG. 4 illustrates the output signals from the charge-coupled device 20 after inputting the reference pattern in FIG. 3. In FIG. 4, x represents the distance from the origin of the coordinate to the left straight line 40, y1′ and y2′ correspond to the sectional distances from the charge-coupled device 20 to the triangles 42 and 45, and f corresponds to the pattern of the parallel lines 44. When x is too large or too small, the charge-coupled device 20 needs to be shifted at x direction. When the average of y1′ and y2′ is too large or too small (the horizontal scan line of the charge-coupled device 20 is too low or too high), then the shift of it the charge-coupled device 20 needs to be shifted at Y direction. When y1≠y2, then the inclination angle of the charge-coupled device 20 needs to be adjusted at θ direction.

In this case, the adjustment of the scanner photoelectric module 22 can be made according to the output signals of the reference patterns by moving the charge-coupled device 20 and the lens 30. However, a drawback is that the charge-coupled device 20 is positioned in three free angles X, Y, and θ, rendering complicated and difficult.

### SUMMARY OF THE INVENTION

Therefore, it is an object of this invention is to provide a method of adjusting scanner photoelectric module by first reducing the adjustable free angles of the charge-coupled device module to one, such as the horizontal direction X or the θ direction around the optical axle, then adjusting the lens module along the optical axle to attain speedy and precise positioning and short manufacturing time.

In the adjustment method of this invention, the width of a document to be scanned is broader than the charge-coupled device module, therefore the charge-coupled device needs not to be exactly located in the center of the scanning area of the lens module, and the charge-coupled device module only needs to be located at corresponding area of the document.

In accordance with the above object, this invention provides a scanner photoelectric module with adjustable lens and charge-coupled device (CCD) module, including a supporting device, a lens module and a charge-coupled device module. The supporting device is arranged on an optical axle and has two planes vertical to the optical axle. The lens module and the charge-coupled device module are arranged on the two planes of the supporting device, respectively. The lens module can be arranged at one side of the supporting device for rotating around the optical axle. The charge-coupled device module can be arranged at the other side of the supporting device for moving horizontally (or rotating around the optical axle).

Further, in an example where the charge-coupled device module is arranged on the supporting device for moving horizontally, a pair of horizontally extended screw holes are arranged at two sides of the charge-coupled device module for fastening the supporting device with an adjustable screw when the charge-coupled device module is moving horizontally (motor-driven) and for adjusting the horizontal location of the charge-coupled device module.

Further, a recessed hole can be formed on the supporting device vertically on the optical axle, for moving the lens module back and forth along the optical axle using an adjustment shaft.

Further, in an example where the charge-coupled device module is arranged on the supporting device to rotate around the optical axle, a round screw hole and a vertically extended screw hole are formed at two sides of the charge-coupled device module. The end with the round screw hole is screwed onto the supporting device with the corresponding cylinder, and serves as a fulcrum of the rotation of the charge-coupled device module around the optical axle. The other end with the vertically extended screw hole is fastened onto the supporting device with an adjustable screw, when the charge-coupled device module is moving at the horizontal direction (stepping motor-driven), for adjusting the inclination of the charge-coupled device module.

### BRIEF DESCRIPTION OF THE DRAWINGS

The aforementioned objects, features and advantages of this invention will become apparent by referring to the following detailed description of a preferred embodiment with reference to the accompanying drawings, wherein:,

FIG. 1 (Prior Art) is a diagram illustrating the relation between a charge-coupled device module and a frame body in a conventional scanner adjustment system.;

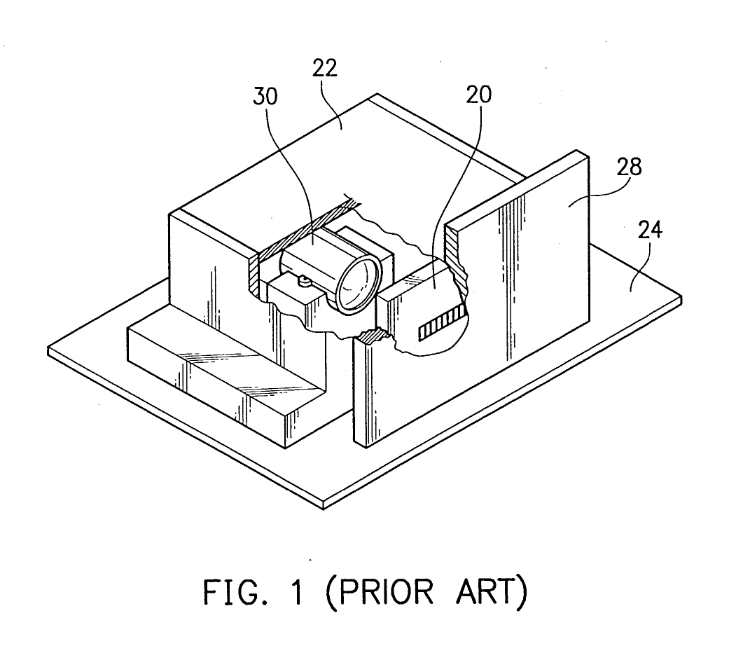

FIGS. 2A and 2B (Prior Art) are diagrams illustrating the relation among a holder, a lens and a frame body in a conventional scanner adjustment system;

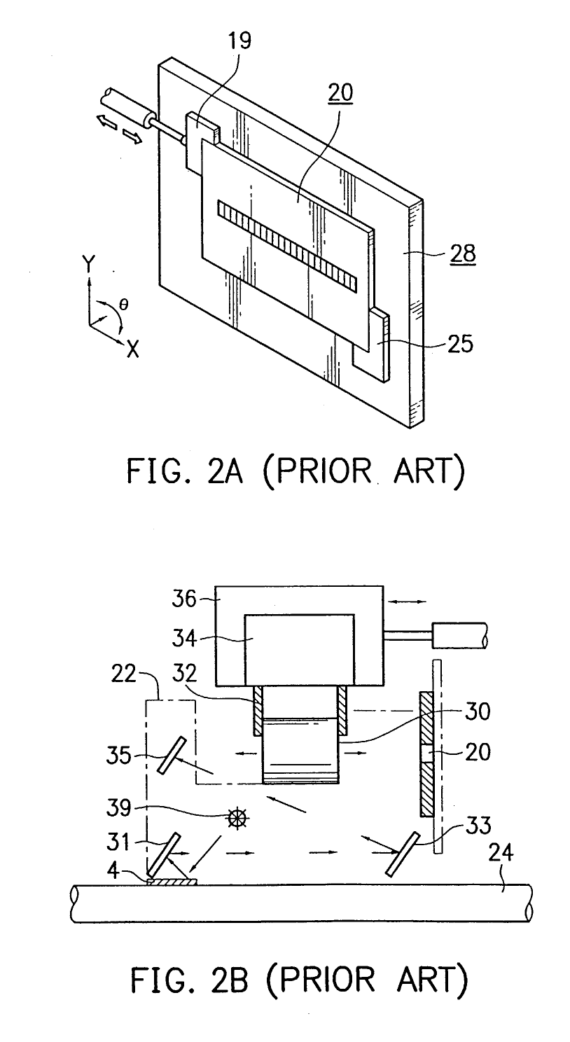

FIG. 3 (Prior Art) illustrates reference scan patterns for a conventional scanner adjustment system;

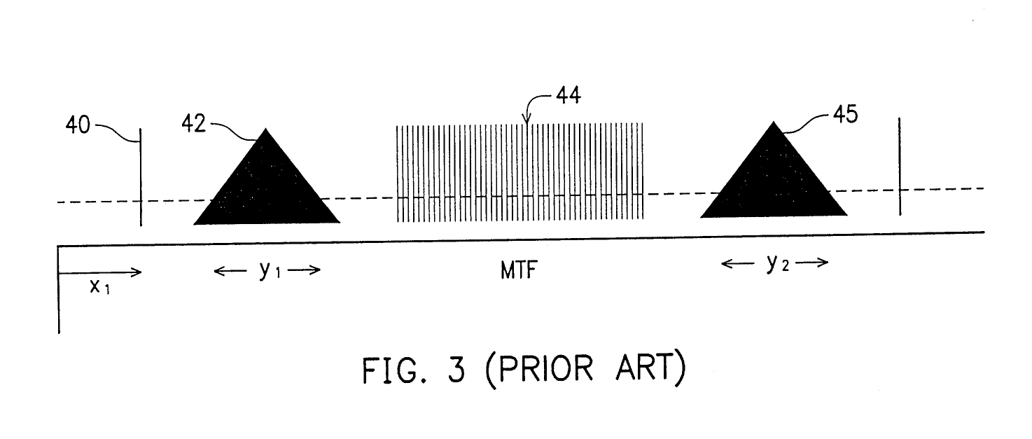

FIG. 4 (Prior Art) illustrates output signals from the charge-coupled device module of the scanner in accordance with the reference scan pattern of FIG. 3;

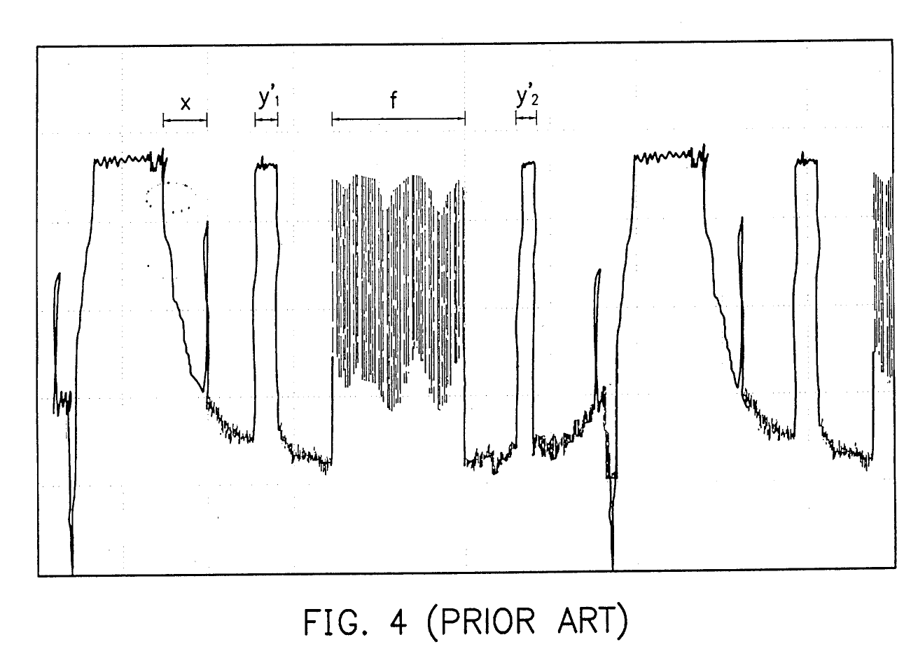

FIG. 5 is a perspective diagram illustrating a first embodiment of the scanner photoelectric module of this invention;

FIG. 6 is a diagram illustrating whether the charge-coupled device module in the scanner photoelectric module of FIG. 5 is placed at the scanning area of an image to be scanned;

FIG. 7 is a diagram illustrating the adjustment of the lens module around an optical axle in the scanner photoelectric module of FIG. 5;

FIG. 8 is a-perspective diagram illustrating a second embodiment of the scanner photoelectric module of this invention; and

FIG. 9 is a diagram illustrating whether the charge-coupled device module in the scanner photoelectric module of FIG. 7 is horizontal.

### DETAILED DESCRIPTION OF THE EMBODIMENTS

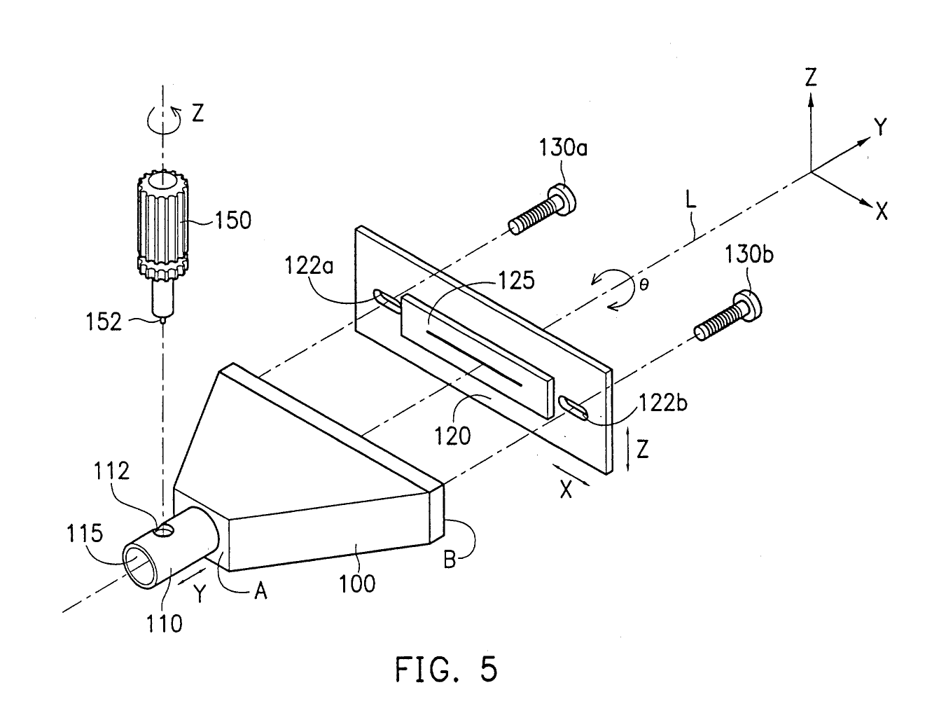

FIG. 5 is a perspective diagram illustrating a first embodiment of the scanner photoelectric module of this invention. In this embodiment, the scanner photoelectric module comprises a supporting device 100, a lens module 110, and a charge-coupled device module 120.

A supporting device 100 is arranged along an optical axle L (Y direction in FIG. 5) and has two planes A and B which are both vertically to the optical axle L. The lens module 110 and the charge-coupled device module 120 are arranged on the two planes A and B of the supporting device 100, respectively. In this example, the lens module 110 is arranged on the plane A, and the charge-coupled device module 120 is arranged on the plane B. The lens module 110 includes a lens 115 for projecting an image to be scanned along the optical axle L to the charge-coupled device 125 of the charge-coupled device module 120, so that the charge-coupled device 125 can output a corresponding image signal.

To adjust the location of the charge-coupled device module 120 at a horizontal direction (X direction), two fixed screw holes (not shown) and two horizontally extended screw holes 122a, 122b are respectively formed on the plane B of the supporting device 100 and at two sides of the charge-coupled device 125 on the charge-coupled device module 120. Thus, the charge-coupled device module 120 can horizontally movably secured on the plane B. Therefore, when the image signal of the image to be scanned being projected by the charge-coupled device 125 through the lens 115 is not at center of the scan area of the charge-coupled device 125, the charge-coupled device 125 (due to the two horizontally extended screw holes 122a and 122b) can move (driven by a motor or other ways) horizontally (X direction) and adjust the image signal to the center of the scan area of the charge-coupled device 125. After the image signal is adjusted to be located at the center of the scan area of the charge-coupled device 125, the charge-coupled device module 120 can screw the charge-coupled device module 120 onto the plane B with screws 130a and 130b through the horizontally extended screw holes 122a and 122b and the screw holes on the plane B of the supporting device 100.

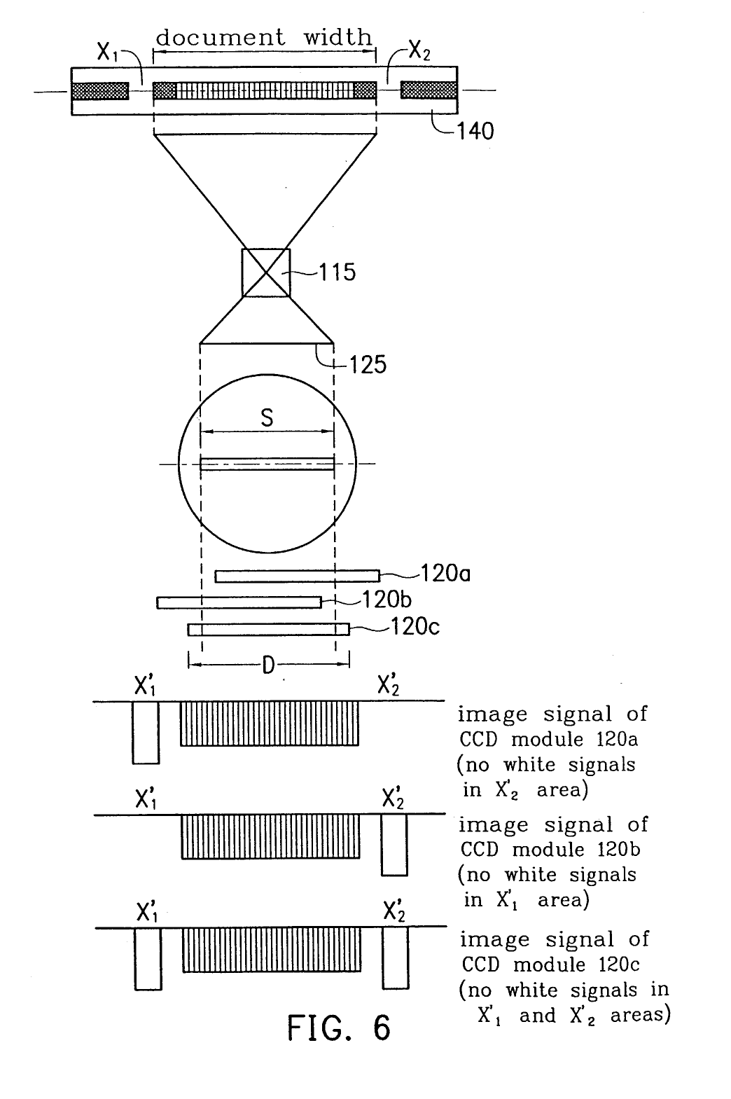

FIG. 6 is a diagram illustrating whether the charge-coupled device module in the scanner photoelectric module of FIG. 5 is placed at the location of the image to be scanned. The ruler pattern 140 defines two block patterns of equal width at two sides of an image (document) to be scanned, respectively. Thus, the white areas x1 and x2 can define the width of the image (document) to be scanned. When the ruler pattern 140 is projected through the lens 115 to the charge-coupled device 125, the generated image signal will have two corresponding areas x1′ and x2′. Assume the length of the image to be scanned (represented by the ruler pattern 140) being projected to the charge-coupled device 125 is S, and the scan area of the charge-coupled device 125 is D (the scan area D of the charge-coupled device 125 is longer than the length S of the image to be scanned being projected to the charge-coupled device 125), when the image to be scanned is not projected to the scan area D of the charge-coupled device 125 (no white signals generated in x1′ or x2′, such as the charge-coupled device modules 120a and 120b in FIG. 6), the charge-coupled device module 120 can use the aforesaid method to adjust horizontally (X direction) to enable the image to be scanned to be projected to the scan area D of the charge-coupled device 125 (white signals generated in both x1′ and x2′, such as the charge-coupled device module 120c). Since the scan area D is usually larger than the length S of the image to be scanned projected to the charge-coupled device 125, the length of the image to be scanned projected to the charge-coupled device 125 only needs to be in the scan area D of the charge-coupled device 125 rather than its center.

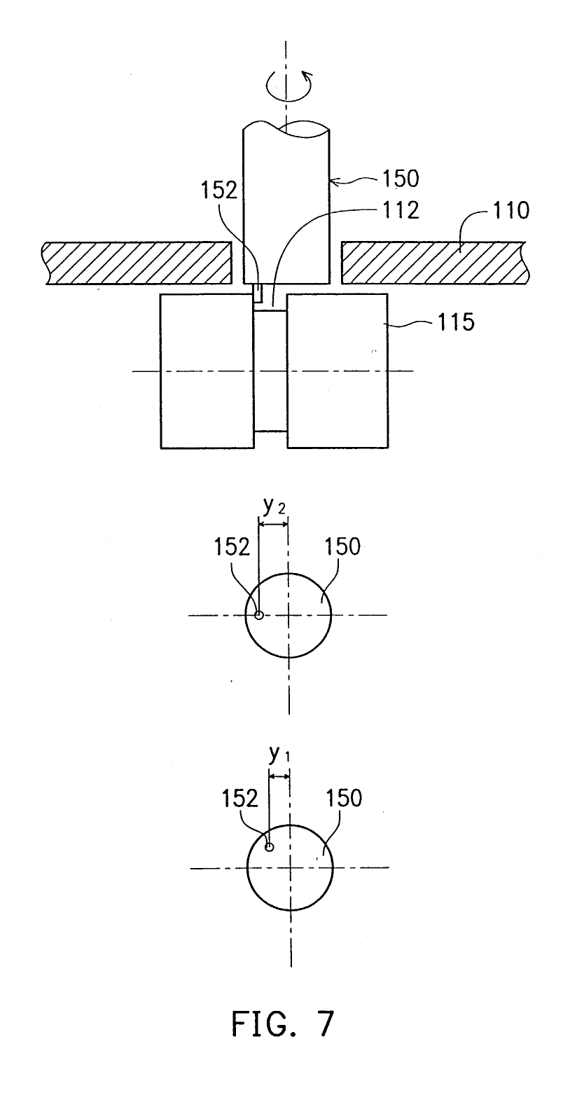

Further, to adjust the location of the lens module 110 along the optical axle L (Y direction), the lens module 110 may define a round opening at a place vertical to the optical axle L, and the lens 115 in the lens module 110 may define a slot 114 corresponding to the round opening 112 (the width of the slot 114 is smaller than the diameter of the round opening 112), as shown in FIG. 7. Thus, if an adjustment shaft 150 with a cam 152 is provided at its top surface and not at the center of the surface, the lens 115 can be activated by the cam 152 through the rotation of the adjustment shaft 150 to move back and forth along the optical axle (Y direction). The bottom part of the FIG. 7 illustrates two relative locations of the cam 152 when the adjustment shaft 150 rotates.

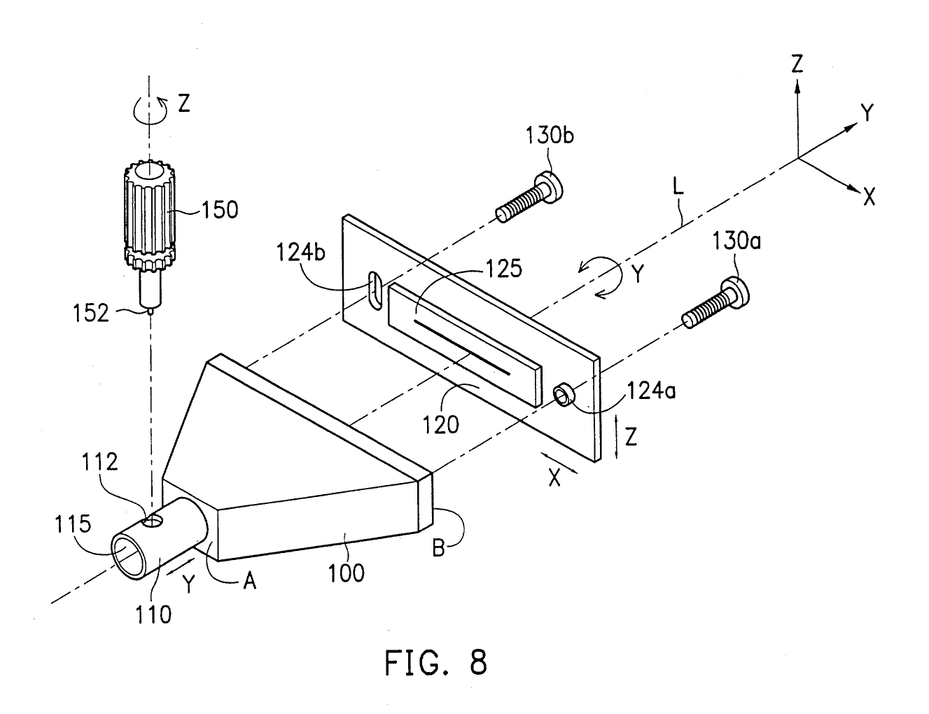

FIG. 8 is a perspective diagram illustrating a second embodiment of the scanner photoelectric module of this invention. In this example, the scanner photoelectric module includes a supporting device 100, a lens module 110 and a charge-coupled device module 120.

The supporting device 100 is arranged on an optical axle L (Y direction) and has two planes A and B arranged vertically to the optical axle L. The lens module 110 and the charge-coupled device module 120 are arranged on the two planes A and B of the supporting device 100, respectively. In this example, the lens module 110 is arranged on the plane A, and the charge-coupled device module 120 is arranged on the plane B. The lens module 110 includes a lens 115 for projecting an image (document) to be scanned along the optical axle L to the charge-coupled device 125 of the charge-coupled device module 120, so that the charge-coupled device 125 can output a corresponding image signal.

To adjust the rotation of the charge-coupled device module 120 around the optical axle (θ direction), a round screw hole and a vertically extended screw hole 124a, 124b are formed at two sides of the charge-coupled device 125 in the charge-coupled device module 120, and a corresponding fixing screw hole and a corresponding vertically extended screw hole (not shown) are also formed on the plane B of the supporting device 100, so that the charge-coupled device module 120 can be secured horizontally on the plane B upon rotating around the optical axle L. Thus, when the image signal of the image to be scanned being projected by the charge-coupled device 125 through the lens 115 is not at center of the scan area of the charge-coupled device 125, the end with the round screw hole 124a can be first fastened on the plane B of the supporting device 100 with a securing screw 130a, then the other end with the round hole 124b can serve as fulcrum to move (driven with a motor or in other ways) the charge-coupled device module 120 to rotate around the optical axle L (θ direction) to project horizontally the image to be scanned to the center of the scan area of the charge-coupled device 125. After the adjustment is completed, the charge-coupled device module 120 can be screwed onto the plane B of the charge-coupled device module 120 with securing screws 130a and 130b through the vertically extended screw hole 124a and 124b and the corresponding screw holes on the supporting device 100.

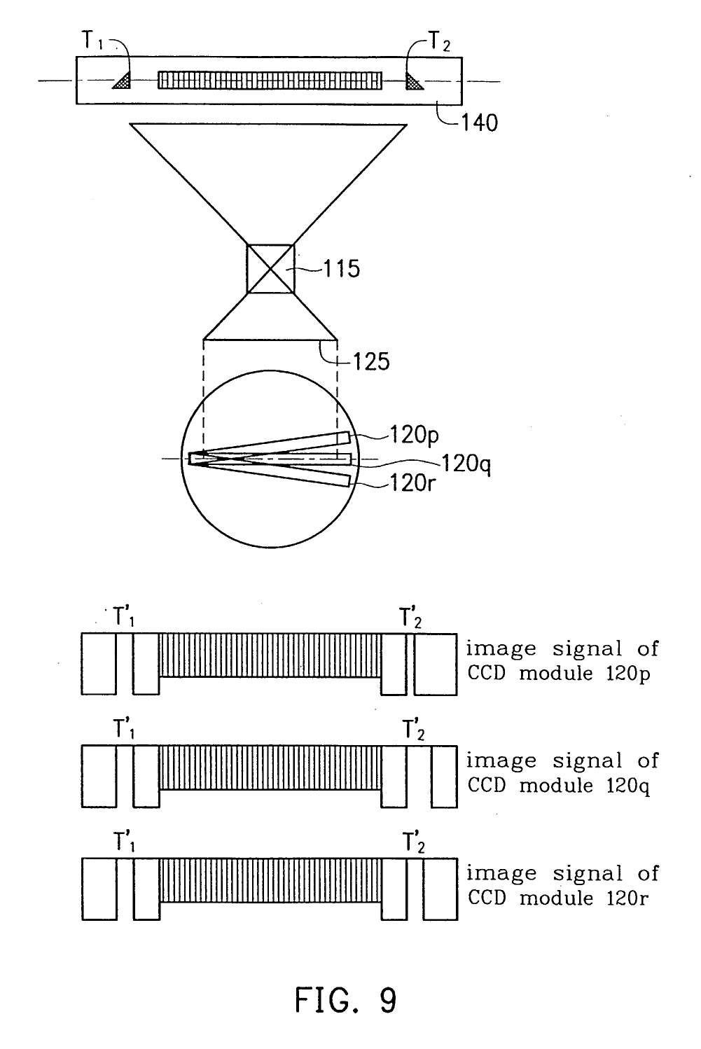

FIG. 9 is a-diagram illustrating the scanner photoelectric module of FIG. 8 for determining whether the image signal is placed horizontally in the scan area of the charge-coupled device module. To achieve this object, the ruler pattern 140 defines the same two width-narrowing patterns, such as the triangular areas T1 and T2, at two sides to determine the horizontal status of the charge-coupled device module 120 with accordance of the corresponding widths. Thus, when the ruler pattern 140 is projected to the charge-coupled device module 125 through the lens 115, the image signal thus generated will have two corresponding areas T1′ and T2′. When the image to be scanned (represented as the ruler pattern 140) is not horizontally projected to the charge-coupled device 125, the corresponding two triangular areas T1 and T2T1′≠T2′ (such as the charge-coupled device module 120p and 120q). At the point, the charge-coupled device module 120 enables the image to be scanned to be projected to the charge-coupled device 25 in accordance with said method, that is, T1′=T2′ or within the permissive range, such as the charge-coupled device module 120r.

Moreover, the movement of the lens module 110 at the optical axle L (Y direction) is the same as that specified in the previous embodiment, its description is therefore omitted.

To summarize, this invention provides a method of adjusting scanner photoelectric module by first reducing the adjustable free angles of the charge-coupled device module to only one, such as the horizontal direction X or rotating around the optical axle at θ direction. Next, adjustment of the lens module at the direction of the optical axle Y is made to attain speedy and precise position and to save the time for manufacturing.

Although the present invention has been described in its preferred embodiments, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A scanner photoelectric module with adjustable lens and charge-coupled device (CCD) module, at least comprising:
a supporting device arranged on an optical axle and having a first plane and a second plane which are both vertical to said optical axle;
a lens module arranged on said first plane of said supporting device for moving along said optical axle; and
a charge-coupled device module arranged on said second plane of said supporting device for moving horizontally.

2. The scanner photoelectric module with adjustable lens and charge-coupled device module of claim 1, wherein two ends of said charge-coupled device module comprise a horizontally extended screw hole, respectively, for securing said charge-coupled device module, after moving horizontally, onto said supporting device with an adjustable screw.

3. The scanner photoelectric module with adjustable lens and charge-coupled device module of claim 1, wherein a recessed hole vertical to said optical axle is formed on said lens module, for moving said lens module back and forth along said optical axle using a cam adjustment shaft.

4. A scanner photoelectric module comprising:
a supporting device arranged on an optical axle and having a first plane and a second plane which are both vertical to said optical axle;
a lens module arranged on said first plane of said supporting device for moving along said optical axle; and
a charge-coupled device module arranged on said second plane of said supporting device for rotating around said optical axle horizontally.

5. The scanner photoelectric module of claim 4, wherein two ends of said charge-coupled device module comprise a round screw hole and a vertically extended screw hole, respectively, wherein the end with the round screw hole is secured onto said supporting device using a corresponding cylinder, the other end with the vertically extended screw hole, after rotating around said optical axle, is secured onto said supporting device using an adjustable screw.

6. The scanner photoelectric module of claim 4, wherein a recessed hole is formed on said lens module vertical to said optical axle, for moving said lens module back and forth along said optical axle using a cam adjustment shaft.
